(19) United States
(12) Patent Application Publication
(10) Pub. No.: US 2012/0061290 A1
(43) Pub. Date: Mar. 15, 2012

(54) CARTON WITH OPENING FOR DISPLAYING PRODUCT

(76) Inventors: Guillaume Delaunay, Rouen (FR); Arnaud Constant, La Vacherie (FR); Boris Letrain, Le Vaudreuil (FR); David Alexandre, Acquigny (FR)

(21) Appl. No.: 13/229,785

(22) Filed: Sep. 12, 2011

(30) Foreign Application Priority Data
Sep. 10, 2010 (EP) 10251574.9

(51) Int. Cl. B65D 5/52; B65D 25/54; B65B 5/02; B31B 1/82; B31B 1/26; B65D 75/36; B31B 1/06

(52) U.S. Cl. 206/769; 206/462; 229/162.5; 493/122; 493/152; 493/162; 53/458

(57) ABSTRACT

Secondary packaging for a primary package or product that is at least about 2 times and preferably 2.5 times as high as it is wide. The secondary packaging has a window in the front wall through which the product partially extends. Support for the product is provided by support extensions formed from the side walls in the form of tabs formed integrally from the blank from which the secondary packaging is formed. The product may be secured against rotation by being adhered to an top support tab. The bottom of the window may be reinforced by a tab that is folded inward and against the interior of the front wall in which the window is formed. Side panels may be provided on the left and right sides of the window to provide lateral support to the product and also to reinforce the left and right sides of the window.

### FIELD OF THE INVENTION

The present invention relates to secondary packaging for a primary package or container or other type of article. More particularly, the present invention relates to a secondary packaging with a window not only through which the primary packaging or container or other type of article is visible but also through which a portion of the primary packaging or container or other type of article projects. Even more particularly, the present invention relates to a secondary packaging with a window and additional support structure for the primary package or container or other type of article, the support structure being formed integrally with and as an extension of the wall panels of the secondary packaging.

### BACKGROUND OF THE INVENTION

Many variants of cardboard or plastic boxes for a primary package (the package that directly contains the product being sold, such as a cream, lotion, cosmetic, shampoo, or therapeutic or skin care product) or container or other type of article (hereinafter “product” for the sake of simplicity without intent to limit) have been proposed, capable of holding the product therein in position for efficient storage and presentation at a retail location. Of such boxes, there also are many variants which include open windows through which the product is visible, and may even project, for an added visual effect. Such windowed boxes either support the product on the bottom wall of the box, or may support the product in a raised position. Raising of the product not only results in a unique visual effect, but also provides additional surface area on the front of the box (e.g., not only above and along the sides, but also below the window) for providing information or other indicia (e.g., branding) related to the product.

One particular variant of a windowed box is described in European patent EP 1 502 862, incorporated herein in its entirety by reference as if fully disclosed herein (and sharing a common inventor with the present invention), in which a box is provided with windows on the front wall as well as the right and left sides thereof. The inventive box has right and left side walls formed to have bellows or gussets which themselves form strips that extend inwardly into the box to provide a support for the tub or pot to be held within and displayed by the box. A panel or flap formed from the front wall is folded inwardly to rest on the strips formed by the left and right side walls. The tub or pot is supported on the flap and may be affixed to the flap and thereby stabilized against undesired movement. Thus, the main surface (typically front) of the tub or pot, which bears the information or markings (hereinafter “indicia” for the sake of convenience without intent to limit) that the manufacturer desires to be always presented for viewing by the consumer, may be maintained in an appropriate position for viewing by the consumer through the front window of the box. The tub or pot thereby is held in a raised position, projects somewhat from the box, and is maintained in a desired orientation so that indicia thereon are maintained in position for ready viewing by consumers. The gusseting of the left and right side walls of the box in combination with the windows in the left and right side walls result in a portion of the tub or pot projecting through the windows of the left and right side walls in addition to the window in the front wall.

It will be appreciated that the above-described box is particularly suitable for a tub or pot having a great enough diameter such that sufficient box material remains to support the tub or pot despite the windows in the right and left side walls as well as in the front wall. It would be desirable to form a box that is narrower than the prior art box and thus which does not have windows in the right and left side walls, yet which provides such benefits of raising the product therein for viewing, allowing at least a portion of the product to project through a window in the box, and maintaining the product in a desired orientation for consumer viewing of indicia on the product.

### SUMMARY OF THE INVENTION

In accordance with the principles of the present invention, a box configured to contain and to display a product is provided with a window through which a portion of the product projects for enhanced display and viewing. In addition, the product is supported in a raised position in the box, and support structures are formed to project from the side walls of the box to provide upper and lower supports for the product to restrain the product from axial movement in the box. Preferably, the box is formed from a single blank such that additional inserts for stabilizing the product within the box are not needed and not provided.

Additional features may be provided to further stabilize the product from movement within the box. For instance, a flap may be provided for fixing the product in place relative to the box. Additional flaps or fins may be provided to stabilize the product within the window and/or to reinforce the box strength along the window. Bellows in the side walls may be formed to stabilize the product against lateral shifting within the box.

These and other features and advantages of the present invention will be readily apparent from the following detailed description of the invention, the scope of the invention being set out in the appended claims.

### BRIEF DESCRIPTION OF THE DRAWINGS

The detailed description will be better understood in conjunction with the accompanying drawings, wherein like reference characters represent like elements, as follows:

FIG. 1 is a perspective view of an exemplary box formed in accordance with principles of the present invention with a product held therein and displayed through the window thereof;

FIG. 2 is an enlarged view of an exemplary support structure formed in accordance with principles of the present invention and illustrated in isolation with bottom of a product to be supported thereby shown in phantom;

FIG. 3 is an exemplary blank from which a box in accordance with principles of the present invention may be formed;

FIG. 4 is a second exemplary blank from which a box in accordance with principles of the present invention may be formed;

FIG. 5 is a perspective view showing a preliminary step in assembling the blank of FIG. 3 into a box in accordance with principles of the present invention;

FIG. 6 is a perspective view showing another step in assembling the blank of FIG. 3 into a box in accordance with principles of the present invention; and

FIG. 7 is a perspective view showing a further step in assembling the blank of FIG. 3 into a box in accordance with principles of the present invention.

### DETAILED DESCRIPTION OF THE INVENTION

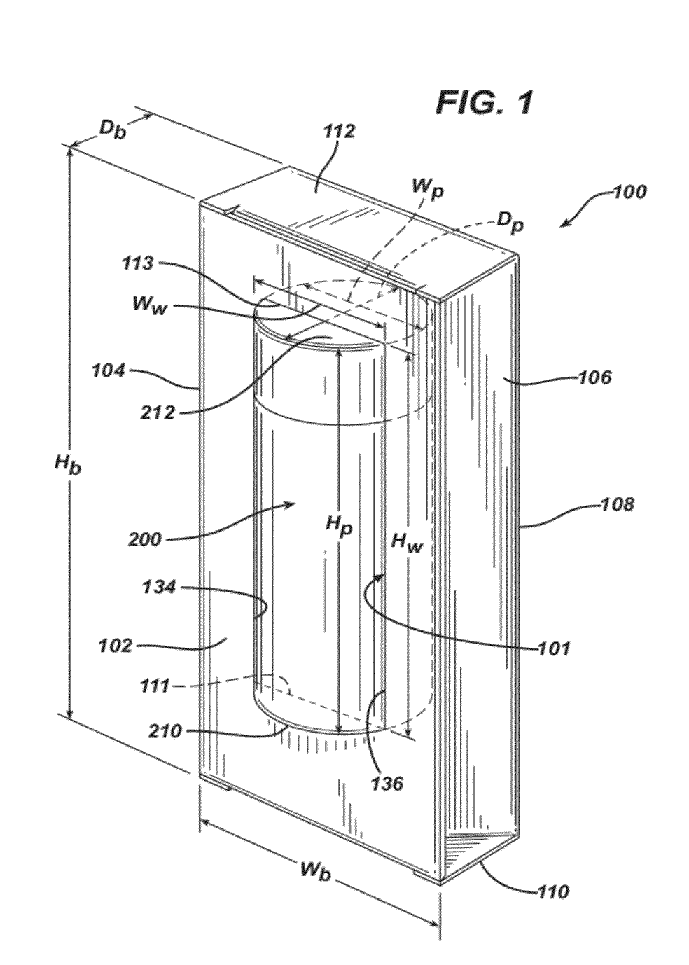

An exemplary box 100 formed in accordance with principles of the present invention is illustrated in FIG. 1 with product 200 displayed in and projecting at least in part through an opening or window 101 within at least one wall of box 100. In the exemplary embodiments of FIGS. 1-7, window 101 is formed in only one wall, the front wall 102, of box 100. It will be appreciated that an additional window may be provided in any or all of left side wall 104, right side wall 106, or back wall 108 of box 100. However, in accordance with one aspect of the present invention, box 100 is formed to contain and to display a relatively narrow product 200 and therefore the structural integrity of box 100 may be compromised if more than one window is provided.

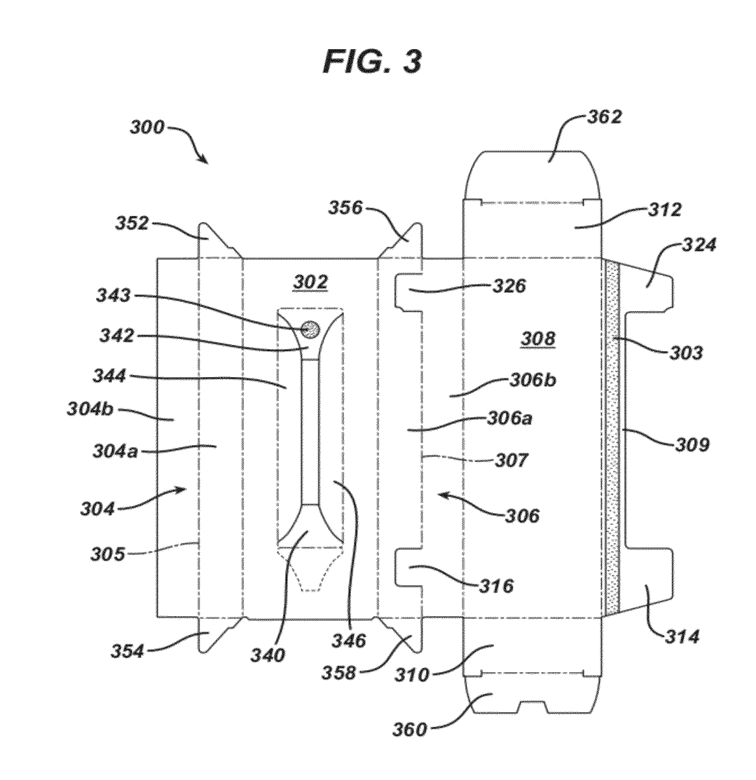

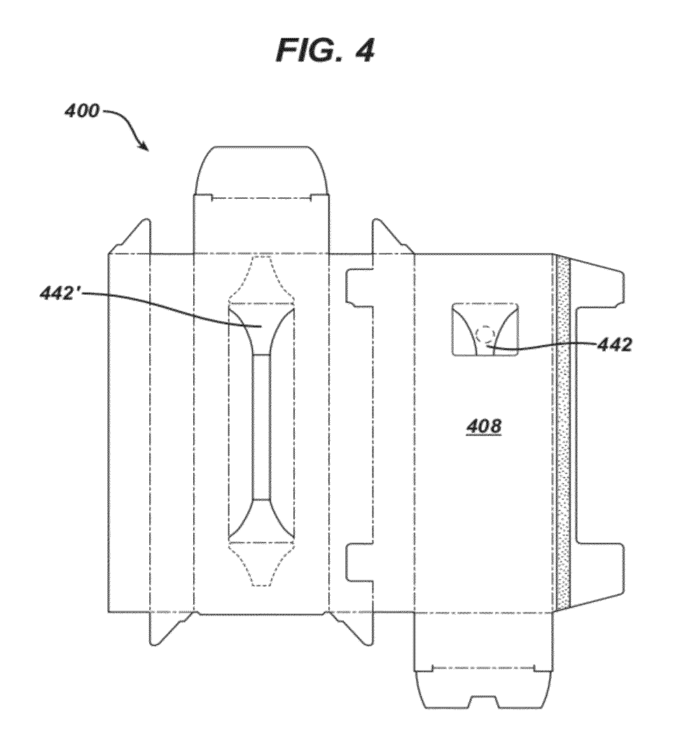

Box 100 is formed in accordance with principles of the present invention to provide stability to product 200, particularly in the case product 200 projects at least somewhat outside box 100 through window 101, and even more particularly when product 200 is displayed elevated above bottom wall 110. Box 100 furthermore may be designed in accordance with principles of the present invention to provide stability to product 200 in the case product 200 is positioned within box 100 spaced below, and thus not abutting and stabilized by, top wall 112. Such stabilizing features will now be described in conjunction with the exemplary embodiment illustrated in FIGS. 1-4. In accordance with one aspect of the present invention, box 100 is formed from a single piece of material (e.g., cardboard, paperboard, or the like) shaped and configured and provided with grooves, cut-outs, preliminary cut-outs, fold lines, and lines of weaknesses (perforations or nicks or score lines) and the like so that no additional separate material or element is necessary to provide the stabilizing functionality desired of the inventive box. Exemplary blanks from which such box may be formed are illustrated in FIGS. 3 and 4, which will be described in further detail below. It will be appreciated that features of box blank 300 of FIG. 3 forming elements of exemplary box 100 are designated with the same reference numbers increased by 200 and redundant description is omitted. Similarly, features of box blank 400 of FIG. 4 forming elements of a box formed in accordance with principles of the present invention are designated with the same reference numbers as the features of box blank 300 increased by 100 and redundant description is omitted.

Referring now to FIG. 1, exemplary box 100 is illustrated in an assembled closed configuration with product 200 therein extending in part through window 101. The overall external shape of box 100 is in the form of a parallelepiped with a height H_{b} greater than width W_{b} or depth D_{b} such that box 100 is generally considered a tall and narrow box for a tall and narrow product such as a canister-like container (e.g., a cylindrical bottle). For instance, the proportions of box 100 preferably are such that height H_{b} is at least about 2 times and more preferably 2.5 times greater than width W_{b} or depth D_{b}. As such, box 100 has preferably only one window, as additional windows cannot readily be accommodated given the relative width W_{b} or depth D_{b} of box 100. The wall in which window 101 is provided (in the exemplary embodiment of FIGS. 1-7, front wall 102) preferably is substantially planar. In addition, window 101 preferably is positioned spaced apart from the edges of the wall in which window 101 is formed so that the material of such wall borders all sides of window 101 (e.g., to permit indicia to be provided on the wall in which window 101 is formed surrounding all sides of window 101). However, other configurations are well within the scope of the present invention. Also as noted above, it will be appreciated that window 101 preferably is spaced from bottom wall 110 so that a product displayed therein is elevated above bottom wall 110. Window 101 has a height H_{w} selected to substantially equal the height Hₚ of product 200 to be displayed therein and to project therethrough. Window 101 has a width W_{w} selected to be less than width Wₚ of product 200 to be displayed therein so that product 200 may project only partially therethrough but is prevented from completely passing through window 101 because of the differences in widths between window 101 and product 200. As may be appreciated, such dimensions of window 101 contribute to stabilization of product 200 within box 100 by virtue of the tight fit of product 200 therein, in the axial direction (along height Hₚ) as well as the lateral direction (along width Wₚ).

Product 200 is further stabilized within box 100 by virtue of depth D_{b} of box 100 being selected to substantially equal depth Dₚ of product 200. Such stabilization by virtue of the dimensions of box 100 relative to the dimensions of product 200 is further enhanced by the provision of uniquely formed side walls 104, 106. In particular, as in EP 1 502 862, side walls 104, 106 preferably are pulled inwardly to have a bellow or gusset configuration. More particularly, side walls 104, 106 preferably each include a vertical fold line 105, 107, respectively, along which side walls 104, 106 are folded inwardly so that a central region of each of side walls 104, 106 projects inwardly into box 100 towards product 200. Preferably, the inner surface of the inwardly directed central regions of each of side walls 104, 106 abuts a side of product 200 so that the bellowed or gusseted side walls 104, 106 together provide lateral stabilization to product 200. The formation of side walls 104, 106 to be bellowed or gusseted not only provides lateral stability, but also reduces depth D_{b} of box 100 to be less than depth Dₚ of product 200 so that product 200 projects at least somewhat outside of box 100 through window 101. As may be appreciated, side walls 104, 106 present, initially, a box that readily receives the full width Wₚ and depth Dₚ of product 200, yet may be folded inwardly to the gusseted or bellowed configuration to present a smaller box depth D_{b} and to cause object 200 to project through window 101.

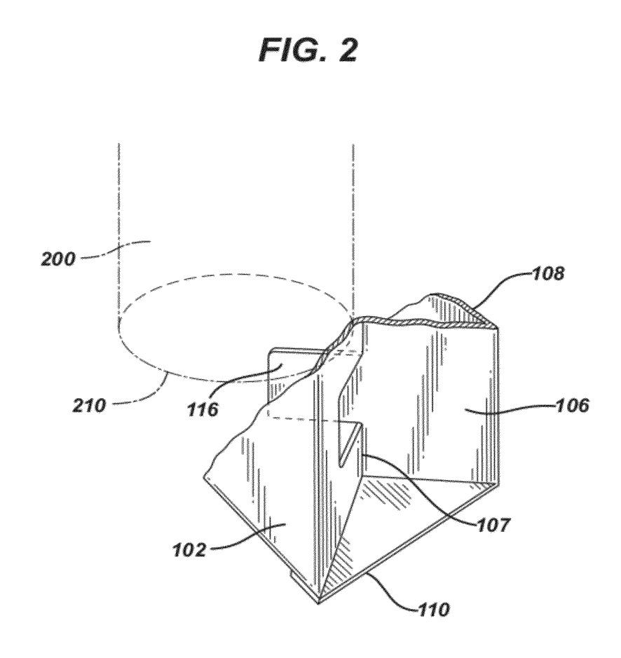

In contrast with EP 1 502 862, as noted above, side walls 104, 106 of box 100 of the present invention preferably do not have windows therein. As such, side walls 104, 106 do not provide upper and lower strips as in EP 1 502 862 to provide support to the bottom and top of product 200. Instead, as may be seen with reference to FIG. 2, an extension, such as in the form of a tab, is formed in at least one, and preferably both (as may be appreciated with reference to FIGS. 3 and 5-7, of side walls 104, 106 to provide upper and/or lower support to product 200. Preferably, at least one upper extension and at least one lower extension extends from at least one, and preferably both, of side walls 104, 106. In the embodiment of FIGS. 1-7, the upper and lower supports preferably are formed as extensions of the panels forming box 100. As such, no additional material is needed to support product 200 within box 100 and assembly of box 100 is simplified (since an extra step of inserting a support element is unnecessary).

Exemplary box 100 preferably is formed from a single blank, such as exemplary box blank 300 illustrated in FIG. 3 or exemplary box blank 400 illustrated in FIG. 4. Box blanks 300 and 400 are single monolithic blanks with a series of panels separated along fold lines about which the panels may be folded to form box 100. Exemplary box blank 300 is illustrated in FIG. 3 as including at least left side wall panel 304 (preferably formed by two portions 304a, 304b coupled along fold line 305, along which left side wall panel 304 is folded to form the above-described gusseted or bellowed configuration), front wall panel 302, right side wall panel 306 (preferably formed by two portions 306a, 306b coupled along fold line 307, along which right side wall panel 306 is folded to form the above-described gusseted or bellowed configuration), back wall panel 308, and left side wall interior panel 309, consecutively arranged and laterally integrally interconnected with one another along vertical fold lines. Panels 304, 302, 306, 309, and 305 are folded along their respective fold lines to form left side wall 104 (upon overlapping of panels 304 and 309, which may optionally be secured with a strip 303 of adhesive or the like), front wall 102, right side wall 106, and back wall 108 of box 100. Support extensions of exemplary box 100 are formed as cut-outs from one of side walls 104, 106 and extensions from the other of side walls 104, 106. More particularly, with reference to the exemplary embodiment of FIGS. 2 and 5-7, left side wall 104 is formed from a left side wall panel 304 of box blank 300 overlapped with (and over) left side wall interior panel 309. As such, bottom left support extension 114 is formed from an extension 314 of left side wall interior panel 309 (specifically, an extension along the free vertical edge of left side wall interior panel 309), such as in the form of a tab. Bottom left support extension 114 preferably has a height substantially equal to the distance of bottom edge 111 of window 101 from bottom wall 110 of box 100 to reach and provide support to bottom 210 of product 200. Right side wall 106 is formed from right side wall panel 306, which is surrounded by wall panels 302, 308 that respectively form front wall 102 and back wall 108. As such, right side wall 106 does not present a free edge from which a support extension may be formed. Instead, bottom right support extension 116 is formed from a cut-out in right side wall panel 306 positioned and configured to form an extension, such as in the form of a tab, which projects inwardly into box 100 to provide support to product 200, as illustrated in FIG. 2. Bottom right support extension 116 preferably has a height substantially equal to the distance of the bottom edge 111 of window 101 from bottom wall 110 of box 100 and thus the height of bottom left support extension 114, thereby reaching and providing support to bottom 210 of product 200 (illustrated in phantom in FIG. 2) positioned in and extending partially out of window 101. It will be appreciated that bottom right support extension 116 preferably extends from right side wall panel portion 306b at an angle with respect to right side wall panel portion 306a. Bottom left side support extension 114 similarly extends at an angle with respect to left side wall panel portion 304b. In combination, bottom left support extension 114 and bottom right support extension 116 support the bottom 210 of product 200 so that product 200 may be at the proper height to project at least in part through window 101.

Top support extensions may be provided in box 100 in a manner similar to the manner in which lower support extensions are provided. Top left support extension 124 preferably is formed from an extension 324 of left side wall interior panel 309 (specifically, an extension along the free vertical edge of left side wall interior panel 309), such as in the form of a tab, having a height substantially equal to the distance of the top edge 113 of window 101 from top wall 112 of box 100, thereby reaching and providing support to top 212 of product 200. And, top right support extension 126 is formed from a cut-out in right side wall panel 306 positioned and configured to form an extension, such as in the form of a tab, having a height substantially equal to the distance of the top edge 113 of window 101 from top wall 112 of box 100 and thus the height of top left support extension 124, thereby reaching and providing support to top 212 of product 200. Preferably, top right support extension 126 extends at an angle with respect to right side wall 106. In combination, top left support extension 124 and top right support extension 126 support top 212 of product 200 so that product 200 may be at the proper height to project at least in part through window 101.

It will thus be appreciated that support extensions 114, 116, 124, and 126 contribute to stabilization of product 200 within box 100 without requiring a secondary support structure to be inserted within box 100. Moreover, support extensions 114, 116, 124, and 126 are readily formed in box blank 300 and readily assembled during assembly of box blank 300 into box 100 (as described in further detail below) to provide the desired support to product 200 without requiring complex assembly steps. Exemplary box blank 400 illustrated in FIG. 4 has similar panels and other features as provided in exemplary box blank 300 of FIG. 3 providing substantially similar functions. Accordingly, a detailed description of exemplary box blank 400 is omitted, reference being made to the description of exemplary box blank 300 as applicable to exemplary box blank 400.

Box 100 formed in accordance with principles of the present invention may be provided with additional features to enhance and/or to increase stiffness and structural stability of box 100. Such features preferably also contribute to the ability of box 100 to maintain its structural integrity (i.e., resistance to being crushed or damaged or otherwise altered in a manner that affects the appearance of box 100) during packing, shipping, and handling, as well as maintaining an undamaged appearance on shelf.

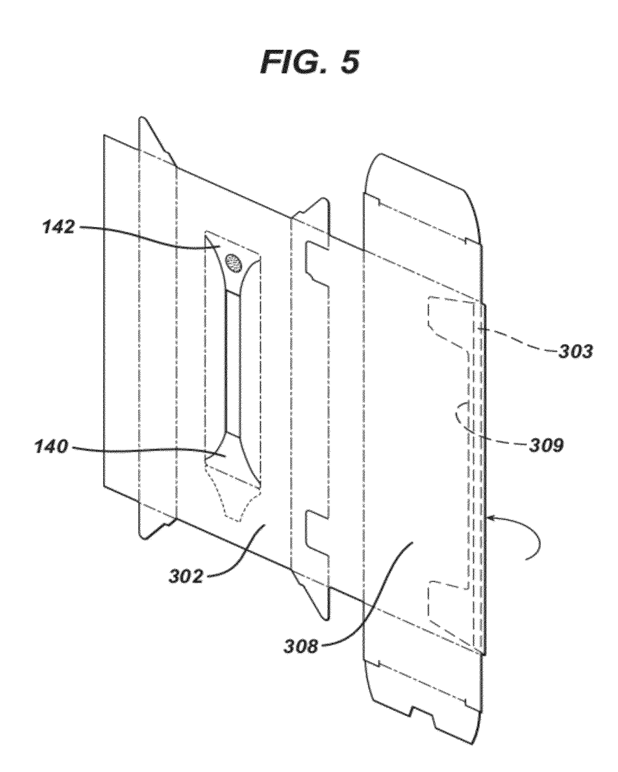

In accordance with one aspect of the present invention, as described above, box 100 and product 200 are selected so that at least a portion of product 200 projects outwardly from box 100 through window 101. As such, the portion of front wall 102 below bottom edge 111 of window 101 may be susceptible to tearing upon axial movement or jolting of product 200 against window 101. In accordance with one embodiment of the present invention, a bottom reinforcing flap 140 is formed along front wall 102 (see FIGS. 5-7) from blank flap 340 folded in along bottom edge 111 of window 101 and against the interior surface of front wall 102. Preferably, bottom reinforcing flap 140 is adhered or otherwise secured to the interior surface of front wall 102. As such, bottom reinforcing flap 140 in conjunction with the lower portion of front wall 102 below window 101 create a double-wall area that reinforces window 101 against forces generating by supporting product 200.

In accordance with a separate and independent feature of the present invention, an top support flap 142 may be formed along front wall 102 (see FIGS. 5-7) from blank flap 342 folded along top edge 113 of window 101. Top support flap 142 may function to stabilize product 200 within box 100, such as against upward movement or against rotation. As such, top support flap 142 may provide the functions provided by the lower flap 24 of EP 1 502 862. If desired, a glue dot 143 advantageously may be utilized to secure product 200 to top support flap 142 thereby securing product 200 against rotation relative to box 100. Undesired or accidental rotation of product 200 relative to box 100, which would have the undesired effect of concealing markings on product 200 intended for ready viewing by consumers, is thus substantially prevented in a particularly reliable and inexpensive and simple manner.

A combination of the above-described wall reinforcement provided by bottom reinforcing flap 140 and product stabilization provided by top support flap 142 may be provided by a modification to the box blank used to form box 100, such as the modification embodied in exemplary box blank 400 of FIG. 4. An top reinforcing flap 442′ is formed in blank 400 similar to blank flap 342 (forming top support flap 142), except instead of being folded to be substantially perpendicular to front wall 102 to provide top support to the top end of product 200, top reinforcing flap 442′ is folded inwardly to be secured to the interior surface of front wall 102 to provide reinforcement to the upper region of front wall 102 above window 101. As such, top reinforcing flap 442′ is similar in function to bottom reinforcing flap 140 described above (such bottom reinforcing flap preferably similarly being provided in box blank 400 to reinforce front wall 102 below window 101). Stabilization of top 212 of product 200 may be provided by an top support flap 442 similar to top support flap 342 formed in box blank 300, except formed from back wall panel 308 rather than from front wall panel 302. More specifically, exemplary box blank 400 provides an top support flap 442 by means of a cut-out in back wall panel 408. Top support flap 442 is folded inwardly into the box formed from box blank 400 similar to the manner in which top support flap 342 of box blank 300 is folded to provide similar support to the top of product 200.

An additional feature which may be provided to strengthen box 100 and/or to stabilize product 200 within box 100 is one or more lateral support flaps or fins along the sides of window 101. In the exemplary embodiment of FIGS. 1-7, left lateral fin 144 and right lateral fin 146, respectively extend from left edge 134 and right edge 136 of window 101, inwardly into box 100. Lateral fins 144, 146 improve rigidity of box 100 by permitting distribution of lateral forces from product 200 against box 100 over at least a portion of the surface of lateral fins 144, 146 instead of merely along edges 134, 136. Contact of product 200 with a greater extent of material—at least a portion of the surface of lateral fins 144, 146, in contrast with an edge of box material at edges 134, 136—provides increased frictional forces against product 200 and thus reduction of movement of product 200 relative to box 100.

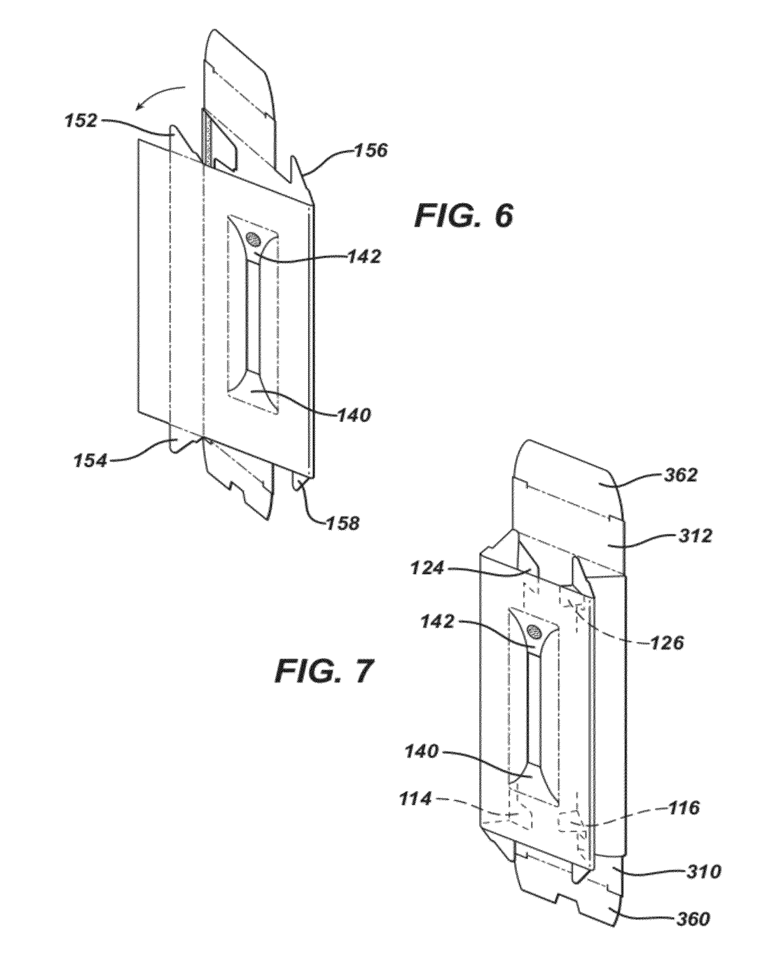

Another arrangement that may be provided to strengthen box 100 and/or to stabilize product 200 within box 100 is the presence of tabs 152, 154, 156, 158 (such as triangular tabs as illustrated in, e.g., FIGS. 6 and 7) extending at the top and bottom ends of side wall panels 304, 306 to fold into box 100 with top wall panel 310 and bottom wall panel 312. Thus, at the bottom edge of box 100, tabs 154, 158 are folded inwardly to lie substantially parallel to and along bottom wall 110 of box 100. Similarly, at the top edge of box 100, tabs 152, 156 are folded inwardly to lie substantially parallel to and along top wall 112 of box 100. When folded within box 100, tabs 152, 154, 156, 158 abut against bottom wall 110 and top wall 112 and tuck-in flaps 360, 362, thereby providing lateral stabilization to box 100. Tabs 152, 154, 156, 158 may be dimensioned to maintain or at least contribute to maintaining the desired bellowed or gusseted configuration of side walls 104, 106. One manner of achieving such effect is by forming each of tabs 152, 154, 156, 158 as an extension from a panel portion 304a, 304b, 306a, 306b of a respective side wall panel 304, 306. Preferably, a single tab is formed along each side wall 104, 106 on only one of the two portions 304a, 304b, 306a, 306b forming the bellow or gusset configuration so that the tab does not unduly interfere with access to product 200 within box 100.

Yet another feature that may be provided in a box formed in accordance with principles of the present invention in combination or independently of the above-described features is an extended top tuck-in flap 360 having a length selected to extend from top wall 112 to top edge 132 of window 101 and thus to top 212 of product 200 to support product 200. In an embodiment providing an top support flap, top tuck-in flap 360 may function to hold the top support flap in place to stabilize top 212 of product 200.

Assembly of box 100 formed of blank 300 is illustrated in FIGS. 5-7 (it being appreciated that assembly of blank 400 into box 100 is substantially the same as assembly of blank 300). Briefly, left side wall interior panel 309 is folded toward the interior surface of back wall panel 308 of blank 300, as illustrated in FIG. 5. Back wall panel 308 is then folded toward front wall panel 302 and left side wall panel portion 304a is adhered to strip 303 on left side wall interior panel 309, thereby achieving a flattened configuration, as FIG. 6, which may be shipped for further assembly at another location if desired. The flattened configuration may be “popped” open, as known to those of ordinary skill in the art, into the configuration illustrated in FIG. 7, causing bottom left support extension 114, bottom right support extension 116, top left support extension 124, and top right support extension 126 to extend inwardly into box 100 into position to support a product 200 to be inserted therein. Folding of top wall panel 310 and top tuck-in flap 360 and bottom wall panel 312 and bottom tuck-in flap 362 to form, respectively, bottom wall 110 and top wall 112 of box 100 may be understood by one of ordinary skill in the art such that illustration of such steps is deemed unnecessary.

It will be appreciated that a box 100 formed with one or more of the above-described features provides and efficient and effective manner of displaying an product 200 in a secure and stable manner through an open window 101 formed in at least one of the walls of box 100. Box 100 provides a consumer with a particularly clear and direct view of the contents of box 100, particularly specific features and/or markings on or other details of product 200. In addition, the consumer can readily touch product 200, enabling a privileged and direct contact with product 200. The configuration of a box 100 with a window through which a portion of product 200 to be contained within box 100 projects results in a box having a relatively small volume and outer dimensions compared with product 200 itself. Such compact size or outer dimensions of box 100 permits a larger number of such boxes to be packed in a given shipping carton or placed on a given area on a retail shelf. Moreover, the reduced size of box 100 requires less material and thus is less costly than a more conventional closed-walled box.

Thus, in accordance with the principles of the present invention, a box is provided with a window through which a product is displayed and may be projected, such box providing positional stabilization of the product with respect to the box to inhibit and to substantially prevent relative movement of the product with respect to the box. In contrast with the box disclosed in EP 1 502 862, a box formed in accordance with the principles of the present invention is dimensioned to correspond to a product that is not sufficiently wide to permit formation of windows in the side walls of the box that may themselves provide some support and may form support structure (in the form of strips) for the product. Instead, the present invention provides integrally formed support structures that extend from the side walls of the box without compromising the integrity of the side walls and thus without weakening the box structure.

It will be appreciated that the directional references “top” or “upper, “bottom” or “lower,” “front,” and “rear” or “back” do not limit the respective panels to such orientation, but merely serve to distinguish these panels from one another. It will also be appreciated that separate and independent aspects of the present invention have been described, each, at least alone, having unique benefits which are desirable for, yet not critical to, the present invention. Accordingly, the various features described herein may be used singly or in any combination thereof. Therefore, the present invention is not limited to only the embodiments specifically described herein.

The exemplary embodiment illustrated in the figures has several separate and independent inventive features, which each, at least alone, has unique benefits which are desirable for, yet not critical to, the present invention. Therefore, the various separate features of the present invention need not all be present in order to achieve at least some of the desired characteristics and/or benefits of the present invention. One or more separate features may be combined, or only one of the various features need be present in a box formed in accordance with the principles of the present invention. Moreover, throughout the present application, reference numbers are used to indicate a generic element or feature of the present invention. The same reference number may be used to indicate elements or features that are not identical in form, shape, structure, etc, yet which provide similar functions or benefits. Additional reference characters (such as letters, as opposed to numbers) may be used to differentiate similar elements or features from one another.

While the foregoing description and drawings represent exemplary embodiments of the present invention, it will be understood that various additions, modifications and substitutions may be made therein without departing from the spirit and scope of the present invention. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. For example, the size or dimensions of the elements may be varied. The presently disclosed embodiments are therefore to be considered in all respects as illustrative and not restrictive, the scope of the invention being indicated by the appended claims, and not limited to the foregoing description.

What is claimed is:

1. A box for containing and displaying a product, said box having a bottom end, a top end, a front side with a window formed therein, a gusseted left side wall, a gusseted right side wall, and a back wall, the box and window being dimensioned such that the product is projected at least in part through said window and supported at least in part by said window spaced above said bottom end, wherein:
a left bottom support extension is formed integrally with and extends from said left side wall;
a right bottom support extension is formed integrally with and extends from said right side wall; and
said left bottom support extension and said right bottom support extension are dimensioned to have a top edge at the same height as a bottom edge of said window to support the bottom of the product.

2. A box according to claim 1, further comprising a bottom wall and a top wall.

3. A box according to claim 1, wherein:
a left top support extension is formed integrally with and extends from said left side wall;
a right top support extension is formed integrally with and extends from said right side wall; and
said left top support extension and said right top support extension are dimensioned to have a bottom edge at the same height as a top edge of said window to support the top of the product.

4. A box according to claim 3, wherein:
a bottom reinforcing flap extends from a bottom edge of said window and is folded inwardly into said box and secured to an interior surface of said front wall to reinforce said front wall in a region below said window.

5. A box according to claim 1, wherein:
a bottom reinforcing flap extends from a bottom edge of said window and is folded inwardly into the box and secured to an interior surface of said front wall to reinforce said front wall in a region below said window.

6. A box according to claim 5, wherein:
a top support flap extends from a top edge of said window inwardly into said box to provide support to the top of the product contained in said box.

7. A box according to claim 6, wherein:
lateral fins are provided on said left side and the right side of said window; and
said lateral fins are folded inwardly into said box to contact the sides of the product within said box.

8. A box according to claim 1, wherein:
a top support flap extends from a top edge of said window inwardly into said box to provide support to the top of the product contained in said box.

9. A box according to claim 1, wherein:
one of said left and right side walls has a free side edge not continuous with another wall panel; and
the support extension extending from said one of said left and right side walls with a free side edge extends from and beyond said free edge.

10. A box according to claim 1, wherein:
a top support flap extends from a top edge of said window inwardly into said box to provide support to the top of the product contained in said box.

11. A box according to claim 1, wherein:
lateral fins are provided on said left side and the right side of said window; and
said lateral fins are folded inwardly into said box to contact the sides of the product within said box.

12. A box according to claim 1, wherein:
at least one of said left and right side walls is formed from a side wall panel positioned between a front wall panel and a back wall panel; and
a support extension is formed in said at least one side wall by a cut-out in said at least one side wall such that said support extension extends at an angle with respect to said at least one side wall.

13. A box according to claim 1, wherein all features thereof are formed from a single unitary blank.

14. A blank having panels arranged to form a box according to claim 1 without completely detaching any panel from the blank.

15. A method of making a box according to claim 1 from a single blank without completely detaching any panel from said single blank, wherein:
said blank is subdivided by fold lines into:
a front side panel with a window formed therein;
a left side wall panel having a fold line therein;
a right side wall panel having a fold line therein; and
a back wall panel;
said blank has first and second edges adapted to overlap when said box is formed; and
said method comprises:
folding said blank along the said fold lines to form a front side, gusseted left side wall, a gusseted right side wall, and a back wall of said box;
overlapping said first and second edges; and
adhering said first edge to said second edge.

16. The method of claim 15, wherein:
a cut-out is formed in at least one of said left and right side wall panels adjacent said fold line therein; and
said cut-out forms a support extension of said box after said blank is folded along said fold line in said at least one of said left and right side wall panels.

17. The method of claim 16, wherein:
said blank includes at least one support extension extending from and beyond one of said edges;
a side wall panel contains the other of said edges; and
said method further comprises adhering said one of said edges with said support extension to the inside of the other of said edges so that said support extension extends inwardly from the fold line in that side wall panel.

18. A method of claim 17, further comprising putting a product inside said box so that a support extension of said box supports the product.

19. The method of claim 15, wherein:
said blank includes at least one support extension extending from and beyond one of said edges;
a side wall panel contains the other of said edges; and
said method further comprises adhering said one of said edges with said support extension to the inside of the other of said edges so that said support extension extends inwardly from the fold line in that side wall panel.

20. A method of claim 19, further comprising putting a product inside said box so that a support extension of said box supports the product.
